(19) United States
(12) Patent Application Publication
(10) Pub. No.: US 2024/0208214 A1
(43) Pub. Date: Jun. 27, 2024

(54) DIRECTING FLUID

(71) Applicant: Hewlett-Packard Development Company, L.P., Spring, TX (US)

(72) Inventors: Lavi COHEN, San Diego, CA (US); Shimi NAKASH, Sant Cugat del Valles (IL); Gil FISHER, Ness Ziona (IL); Anatoliy SLAVKIN, Ness Ziona (IL)

(73) Assignee: Hewlett-Packard Development Company, L.P., Spring, TX (US)

(21) Appl. No.: 17/907,113

(22) PCT Filed: Mar. 26, 2020
(86) PCT No.: PCT/US2020/024882

§ 371 Date: Sep. 23, 2022

(51) Int. Cl. B41J 2/07; B41J 2/005; B41J 2/04; B41J 3/407

(52) U.S. Cl. CPC B41J 2/07; B41J 2/0057; B41J 2/04; B41J 3/40733

(57) ABSTRACT

In one example a fluid ejection device comprises a housing and a deflector arm. The housing comprises a first housing portion and a second housing portion defining a fluid ejection aperture therebetween. The fluid ejection aperture is to direct fluid towards a roller. The deflector arm is movable within the fluid ejection aperture between first and second positions. In the first position, the deflector arm is proximate the second housing portion to thereby direct fluid between the deflector arm and the first housing portion and toward a target area on a surface of the roller. In the second position, the deflector arm is proximate the first housing portion to thereby direct fluid between the deflector arm and the second housing portion. The second housing portion comprises a curved surface such that, when the deflector arm is in the second position, fluid is directed away from the target area.

### BACKGROUND

In some printing operations, a print agent such as a coating or varnish or primer may be applied to a roller for subsequent transfer to a substrate.

### BRIEF DESCRIPTION OF DRAWINGS

Examples will now be described, by way of non-limiting example, with reference to the accompanying drawings, in which:

FIGS. 1A and 1B are simplified schematic cross sections of an example device;

FIGS. 2A and 2B are simplified schematic cross sections of an example device;

FIG. 3 is a simplified schematic perspective view of an example device; and

FIG. 4 is a simplified schematic underside view of an example device.

### DETAILED DESCRIPTION

Some examples herein relate to forming a pattern of fluid (e.g. liquid) on the surface of a roller. The fluid may comprise a varnish or a coating or a primer and the roller (to which the fluid is applied) may comprise an anilox roller. For example, the anilox roller may comprise a roller having a plurality of pores (e.g. indentations or cavities) such that when fluid is deposited onto a surface of the anilox roller the fluid is retained in the pores. The anilox roller may then be rotated into contact directly with a substrate (or print media etc.) to transfer the fluid thereon to the substrate (or rotated into contact with another, intermediate, roller which will transfer the fluid to the substrate). The selective discharge of the fluid retained in the pores will cause a fluid image to be formed on the anilox roller by those pores that still retain their fluid, and therefore cause that fluid image to be transferred to the substrate. For example, it may be that certain areas of the substrate are not to be coated with the fluid (e.g. the varnish or coating) in which case, if the anilox roller is coated with a layer of fluid then the fluid may be removed from certain pores so that those corresponding areas of the substrate are not coated with the fluid.

Some examples herein accomplish the selective removal, or selective discharge, of fluid within a pore of the anilox roller (in order for form a target image onto the substrate) by use of an air knife. According to some examples, an air knife provides a continuous flow of fluid (for example, the fluid may comprise a gas, for example, air)—for example a “jet flow”—toward the anilox roller. The air knife may extend along the surface of the anilox roller. Put another way, the anilox roller may comprise a length and the length of the fluid flow from the air knife may correspond (e.g. substantially correspond) to the length of the roller. In this way, the air knife is able to jet an air flow towards all of the pores of the anilox roller to (selectively, as will now be explained) discharge fluid being retained in the pores. The air knife may be to direct a line of air (or a strip of air) toward the anilox roller as will be explained in more detail later. According to some examples, the air knife comprises a movable element (for example a piezoelectric element or electrically controlled element) that is disposed in a fluid channel of the air knife. The air knife is to discharge fluid through the fluid channel and the movable element is movable between two positions, each position creates a fluid channel defined by one side of the movable element and a housing of the air knife (e.g. a housing defining an interior surface of the channel).

For example, the movable element may be located in a first position in which fluid is directed between the element and a first housing of the air knife and in a second position in which fluid is directed between the element and a second housing of the air knife. The element may be movable between these two positions and therefore movable between positions in which fluid is directed through one of two channels. In one position the movable element may be positioned such that fluid is directed toward the anilox roller to discharge any fluid in a pore of the anilox roller and in the other position the deflector arm may be positioned such that fluid is directed away from the anilox roller. In other words, the movable element may be movable so as to direct air toward, or away from, the anilox roller to discharge or to not discharge the pores of the anilox roller. The movable element may be movable so as to selectively discharge the pores of the anilox roller (by moving the movable element between its first and second positions). The air knife may comprise a plurality of movable elements along its length such that all of the pores along the length of the anilox roller may be selectively discharged (e.g. discharged or not). The movable element is therefore effectively caused to move to an appropriate position according to whether a pore, or a set of pores, is to be discharged.

In some examples, a curved blade may be placed proximate one of the air channels (e.g. proximate the discharged fluid when the movable element is in the position to direct fluid away from the pores of the anilox roller and therefore not to discharge the pores of the anilox roller) to deflect the air away from the pores of the anilox roller. For example, in a first position of the movable element, fluid may be directed towards a pore of the anilox roller (to thereby discharge any fluid in the pore) but in a second position of the movable element, fluid may be directed towards a curved blade such that the blade's curvature directs air away from the anilox roller and therefore away from its pores (in this way those pores retain any fluid present therein). As will be explained below, at least part of the housing of the air knife, according to some examples herein, is curved so as to direct air away from the anilox roller by utilising the Coanda effect. In this way, the end of the air knife is able to be closer to the surface of the anilox roller (since the space between the two components need not be sized to accommodate the curved blade), and the air knife itself is to direct the air away from the anilox roller without the use of another component (which may involve bespoke manufacture). These, and other examples, will now be described with reference to the accompanying drawings.

Some examples presented herein therefore accomplish directing air away from the anilox roller, selectively, without the use of a second component (e.g. a curved blade) which may be expensive or difficult to manufacture (e.g. due to tolerances) and, in turn, if a secondary component is not used then the air knife is able to be positioned closer to the anilox roller. In this way the length of the “gap” between the air knife and the surface of the anilox roller may be decreased. This decreased distance increases the efficiency of the air knife.

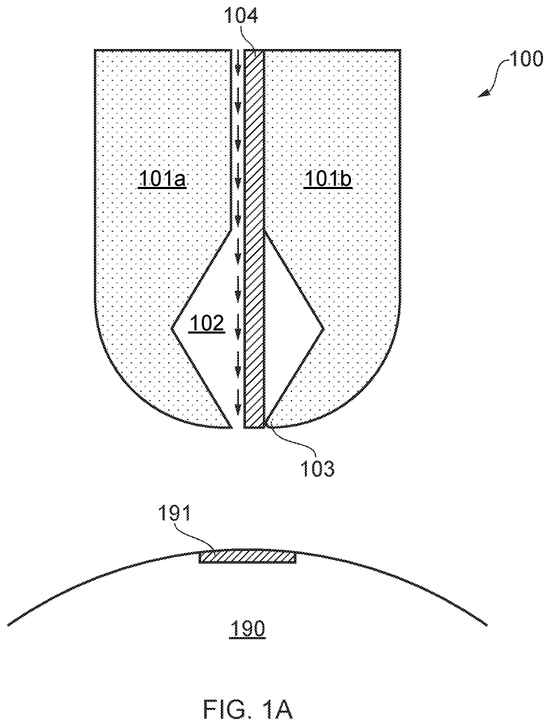

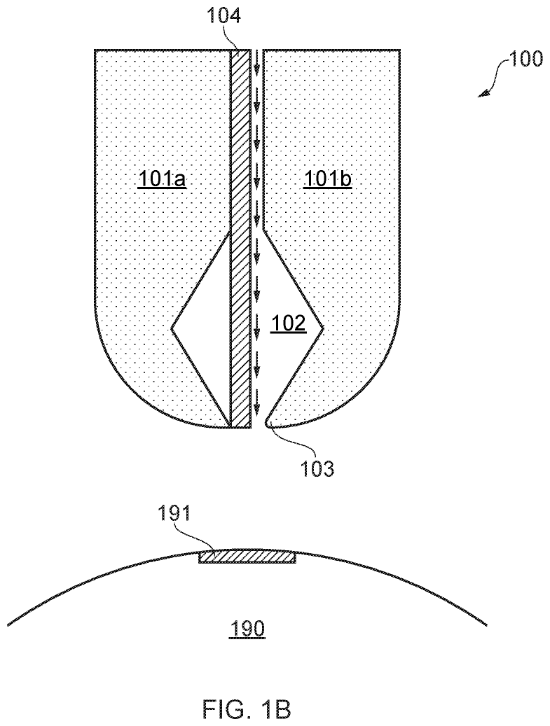

FIGS. 1A and 1B show a fluid ejection device 100 (which may also be considered an apparatus for directing a fluid or a fluid delivery unit). The fluid ejection device comprises a housing 101 which comprises a first housing portion 101a and a second housing portion 101b. The first and second housing portions 101a, 101b define a fluid ejection aperture 102 therebetween. The fluid ejection aperture 102 is to direct fluid (e.g. a gas, e.g. air) towards a roller 190. The fluid directed by the fluid ejection aperture 102 may comprise a printing fluid (e.g. a liquid) such as an ink, or a different fluid (e.g. a liquid) such as a varnish, or a coating or a primer etc., to be directed towards a target area 191 on the roller 190. The roller 190 may comprise an anilox roller and may comprise a number of pores (or indentations or cavities—not shown in FIGS. 1A and 1B) for retaining fluid. For example, the target area 191 may comprise pores whose contents are to be discharged.

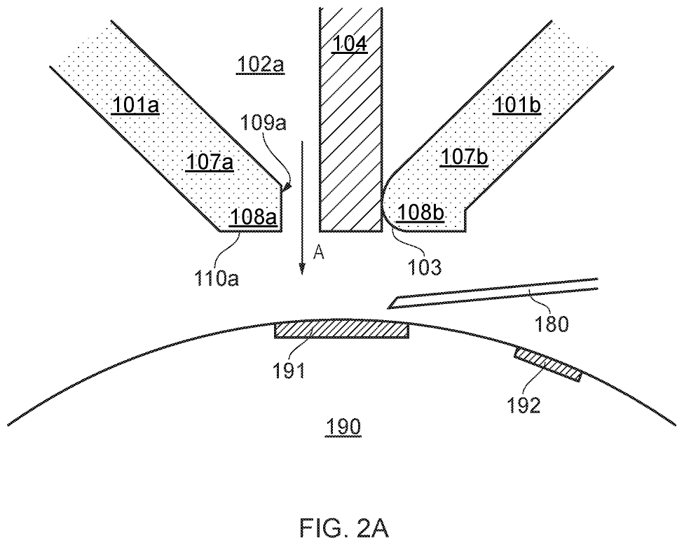

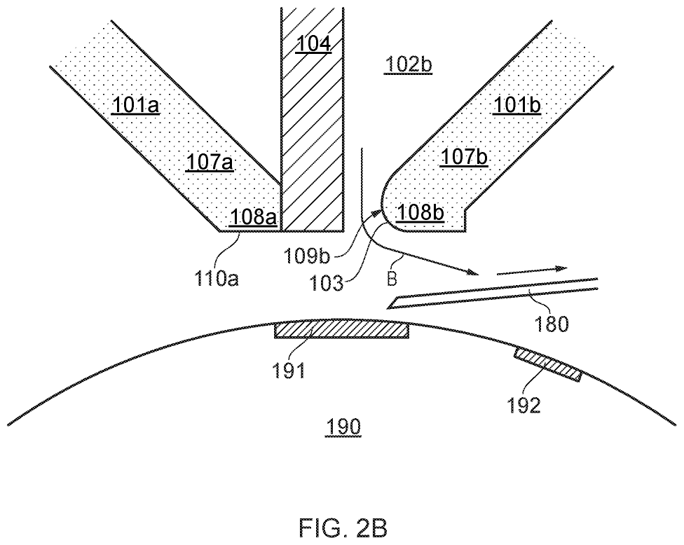

The fluid ejection device 100 comprises a movable element in the form of a deflector arm 104. The deflector arm 104 is movable within the fluid ejection aperture 102 between a first position and a second position. The first position of the deflector arm 104 is shown in FIG. 1A. The second position of the deflector arm 104 is shown in FIG. 1B. In the first position (FIG. 1A) the deflector arm 104 is proximate the second housing portion 101b to thereby direct fluid between the deflector arm 104 and the first housing portion 101a. This is shown by the arrows in FIG. 1A. In the second position (FIG. 1B) the deflector arm 104 is proximate the first housing portion 101a to thereby direct fluid between the deflector arm 104 and the second housing portion 101b. This is shown by the arrows in FIG. 1B. Referring to FIG. 1A, when the deflector arm 104 is in the first position, the fluid ejection device 100 is to direct fluid towards the target area 191 of the roller. The second housing portion 101b comprises a curved surface 103 such that when the deflector arm 104 is in its second position, shown in FIG. 1B, fluid is directed away from the target area 191 due to the Coanda effect. This will now be described in more detail with reference to FIGS. 2A and 2B.

FIGS. 2A and 2B each, respectively, depict an enlarged area of the fluid ejection device 100 shown in FIGS. 1A and 1B, to illustrate some examples of this disclosure. Accordingly, FIG. 2A depicts the deflector arm 104 in its first position and FIG. 2B depicts the deflector arm 104 in its second position. In the first position (FIG. 2A), the deflector arm 104 and first housing portion 101a define a first fluid channel 102a and in the second position (FIG. 2B) the deflector arm 104 and the second housing portion 101b define a second fluid channel 102b. FIG. 2B shows that the curved surface 103 of the second housing portion 101b defines an opening for the second fluid channel 102b. As is also apparent from FIGS. 2A and 2B, the curved surface 103 defines a curved edge of the opening of the fluid channel 102b (and also a curved edge of the opening of the fluid ejection aperture 102).

The first housing portion 101a defines, or comprises, a first arm 107a extending away from a main body housing 101 of the device 100. The second housing portion 101b defines, or comprises, a second arm 107b extending away from a main body housing 101 of the device 100. The device therefore comprises first and second opposing arms 107a, 107b defining a fluid channel 102 therebetween. Each of the first and second arms extends away from, and back towards, the main body housing 101 so as to define a fluid chamber (e.g. fluid chambers 102a, 102b) therein, the fluid chambers being delimited by a respective one of the first and second housings 101a, 101b and the deflector arm 104. In other words, the first arm 107a extends away from, and back towards, the main body housing 101 so as to define a first fluid chamber 102a between the first housing 101a and the deflector arm 104, and the second arm 107b extends away from, and back towards, the main body housing 101 so as to define a second fluid chamber 102b between the second housing 101b and the deflector arm 104. The first arm 107a comprises a first end 108a having a first end face 109a. The first end 108a of the first arm 107a comprises a second end face 110a. In this example, the first end face 109a and the second end face 110a are at an angle of approximately 90 degrees but in other examples the angle between the first and second end faces 109a, 110a may be different. The first end face 109a comprises a flat face. Put another way, the first end face 109a is flat. For example, the first end face 109a is not curved. The first end face 109a therefore defines a sharp, or not curved, or substantially right-angled, edge to the first housing 101a. This is to ensure that air directed toward the target area 191 of the roller 190 is not deflected away from the target area 191 but is rather permitted to flow toward the target area 191. In other words, the first end face 109a and/or the first end 108a of the first arm 107a is shaped so as to direct fluid through the first opening 102a toward the target area 191 of the roller 190. This is shown by air flow arrow A in FIG. 2A. The target area 191 comprises a number of pores filled with a fluid and whose contents are to be discharged by the air exiting the device 100 (air A) at the first fluid channel 102a. In other words, the deflector arm 104 in the FIG. 2A position is to direct air A towards a target area 191 of the roller 190 to discharge the contents of a (not shown) pore of the roller 190 or a set of pores of the roller.

By contrast, the second arm 107a comprises a first end 108b and the first end 108a of the second arm 107a is curved. For example, the first end 108b comprises a curved profile. For example, the first end 108b curves away from the device and/or away from the deflector arm 104. For example, the first end 108b curves away from the fluid ejection apertures 102 and/or away from the first and/or second fluid channels 102a, 102b. The first end 108b may curve away from the first housing 101a and/or of the first arm 107a and/or the first end 108a. The first end 108b comprises a curved end face 109b, or curved end edge 109b, which, as above, curves away from the deflector arm 104 and/or the fluid aperture or channels 102, 102a, 102b etc. The housing 101 therefore comprises two opposing housing ends (108a, 108b) respectively comprising a straight edge (edge 109a) and a curved edge (edge 109b). The curved surface 103 therefore curves away from the second fluid channel 102b to change the direction of fluid as fluid exits the opening of the second fluid channel 102b. This is shown by air flow arrow B in FIG. 2B. As shown by arrow B, the curvature of the curved housing 103 (e.g. the curved end 108b and/or the curved end edge 109b thereof) is such that the air is directed away from the target area 191 of the roller (and away from the roller 190), and away from the (not shown) pores of the roller. The device therefore comprises a sharp edge, or a sharp armature, and a rounded edge, or rounded armature—the sharp edge being to direct air in a substantially straight direction relative to the device housing and the curved edge to bend or curve the air.

The curvatures of the airflow (arrow B) is due to the Coanda effect. The Coanda effect refers to the characteristic of a jet flow to attach itself to a nearby surface and remain attached to the surface even when the surface curves away from the initial direction of jet flow. In the examples describe herein, the surface of the device is curved so as to cause the airflow to be diverted from (or curve/bend away from) a surface of the anilox roller due to the Coanda effect. Whilst some examples may employ a curved blade to direct the expelled air from the device 100 away from the roller 190, in the depicted examples herein the housing 101 of the device 100 comprises a curved surface, or edge, so as to utilise the Coanda effect to curve the jet airflow away from the surface of the roller 190. In other words, the curved surface 103 may be such that fluid exiting the device at the fluid channel 102b attaches to the curved surface 103 by virtue of the Coanda effect to bend away from the surface of the roller 190.

So that the (curved) airflow B does not come into contact with the roller 190 (e.g. at a part of the surface of the roller 190 remote from the target area 191—schematically indicated at 192) according to some examples there is also provided a deflector 180, for example a deflector blade. The deflector 180 may comprise a substantially straight (e.g. not curved) deflector. In these examples the deflector 180 is to receive the airflow (e.g. the curved airflow from the second opening 102b) and (continue to) direct the airflow away from the surface of the roller 190. The deflector 180 may therefore be to prevent fluid that has exited the opening of the second fluid channel from being directed towards the roller 190.

The deflector arm 104 may therefore comprise a movable guide element for directing fluid, movable between a first position in which the guide element is to direct fluid towards a first fluid outlet (e.g. between the surface 109a and the guide element) and out of the device (or apparatus) in a first direction (e.g. towards the target area 191 of the roller 190), e.g. direction A and as depicted in FIGS. 1A and 2A, and a second position in which the guide element is to direct fluid towards a second fluid outlet which comprises a curved edge such that fluid is directed out of the device in a second direction, e.g. direction B (e.g. the second fluid outlet may be between the surface 109b and the guide element) and as depicted in FIGS. 1B and 2B. The second direction is different to the first direction, as shown in FIGS. 2A and 2B. The first and second directions may therefore be non-parallel. The second direction may be substantially at right-angles to the first direction. The curved surface 103, or edge, therefore curves such that the direction of fluid changes as the fluid exits the opening.

In some examples, therefore, the device 100 may comprise a fluid delivery unit that is operable in first and second modes. The first mode of the unit is depicted in FIGS. 1A and 2A and the second mode of the unit is depicted in FIGS. 1B and 2B. In the first mode the unit is to direct fluid through a first fluid channel (e.g. 102a) towards the surface of a roller 190 and in the second mode the unit is to direct fluid through a second fluid channel (e.g. 102b) having an opening having a curved surface (e.g. 103), the curved surface being to cause fluid to be deflected away from the surface of the roller 109.

In some examples the device comprises a single fluid channel 102 which if separated, or partitioned, into the two fluid channels 102a and 102b by the deflector arm 104. An inlet may feed airflow and/or pressure into the fluid channel 102 and therefore, in some examples, the flow channels 102a, 102b are fed from the same inlet of airflow and/or pressure. The deflector arm 104 is therefore movable in these examples to direct the airflow to one of the two sides of the deflector arm 104 to therefore direct the airflow in one of the two fluid channels 102a, 102b. The deflector arm 104 is therefore movable to seal one of two openings so that air is not permitted to enter one of the two fluid channels 102a, 102b but is permitted to enter the other one of the fluid channels 102a, 102b. More specifically, when the deflector arm 104 is in the first position (FIG. 2A), the deflector arm 104 is to seal the second fluid channel 102b and in the second position (FIG. 2B), the deflector arm 104 is to seal the first fluid channel 102a. In this way, when one fluid channel 102a, 102b is opened the other is sealed. In this way, the deflector arm 104 is movable to seal one fluid channel and to open another fluid channel. The deflector arm 104 is therefore movable to selectively seal and/or open a fluid channel of the device 100.

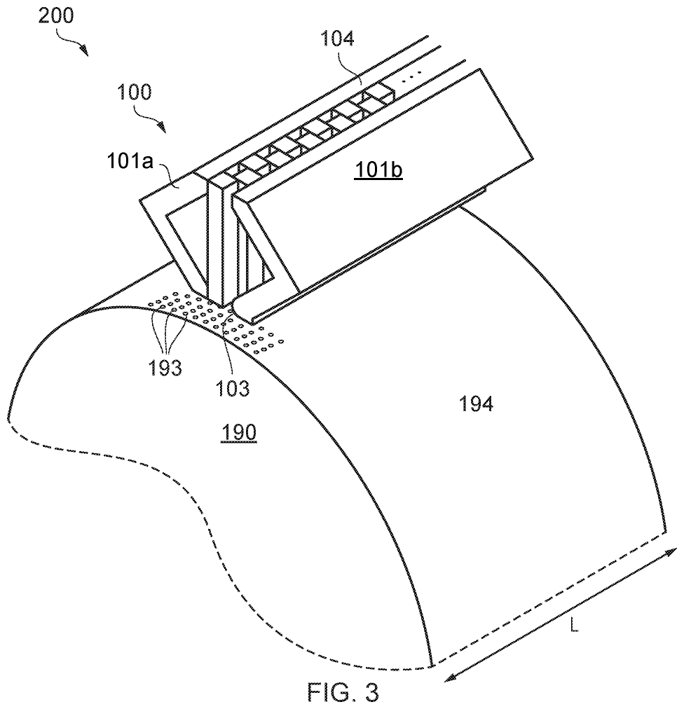

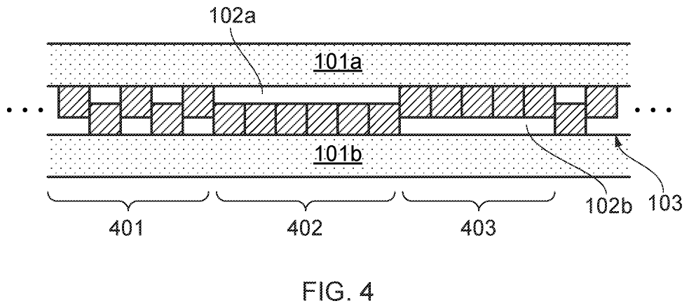

FIG. 3 shows a perspective view of one example roller 190 and an example device 100 (for example, comprising any of the devices as described above with reference to FIGS. 1A-2B). The cross-sections depicted in FIGS. 1A, 1B and/or 2A, 2B may comprise a cross-section through the device 100 depicted in FIG. 3. As shown in FIG. 3, the roller comprises a number of pores 193 (which may also be referred to as holes, openings, indentations or cavities etc.) each of which is to hold and/or retain a volume of fluid (e.g. a liquid). The device 100 in the FIG. 3 example comprises a plurality of deflector arms 104. Fluid (e.g. gas, e.g. air) directed toward the roller 190 by the device 100 may be directed toward a pore 193 of the roller 190 to discharge fluid retained therein or may be deflected away from a pore 193 so as not to affect the fluid retained by that pore depending on the operational state, or mode, of the device, as determined by the position of the deflector arms 104. More specifically, fluid (e.g. air) directed toward a portion of the surface of the roller 190 by the device 100 when the deflector arm is in the first position may be directed toward a pore 193 of the roller 190 to discharge fluid retained therein or, when the deflector arm is in the second position, may be deflected away from a pore 193 so as not to affect the fluid retained by that pore. FIG. 3 shows the roller 190 having a length L and pores 193 that extend the length of the roller. In this example the pores 193 also extend the diameter of the roller such that substantially all of the cylindrical outer surface of the roller 190 comprises a pore 193. The device 100 extends substantially all along the length L of the roller 190. The curved surface 103 of the device 100 extends along the length L of the roller 190. FIG. 3 shows that the curved surface 103 comprises a curved edge of the device 100 that extends the length of the device 100. In other words, the curved edge is continuous along the length of the device. The curvature may be constant along the length of the device. Each deflector arm 104 may comprise the deflector arm 104 as described above with respect to FIGS. 1A-2B. In other words, any one, or each, of the deflector arms 104 of the device 100 of FIG. 3 may be movable between first and second positions. In the first position, the or each deflector arm is proximate the second housing portion 101b and in the second position the or each deflector arm is proximate the first housing portion 101a. This is shown more clearly in FIG. 4 which is an underside view of the device 100 of FIG. 3.

FIG. 4 shows the underside of part of the device 100. As shown in FIG. 4 each one of the plurality of deflector arms 104 is either in a first position or a second position (these positions being as described above). For example, the depicted part of the device in FIG. 3 comprises three regions—401, 402, and 403. The plurality of deflector arms in the region 402 are all proximate the second housing portion 101b. In other words, the plurality of deflector arms in the region 402 are all in the first position defining a fluid channel 102a for fluid to be directed towards a region of pores 193 on the surface of the roller 190. The plurality of deflector arms in the region 403 are all proximate the first housing portion 101a. The deflector arms in the region 403 are all in the second position defining a fluid channel 102b for fluid to be directed away from a region of pores on the surface of the roller 190 due to the curved surface 103 of the housing portion 101b which runs the length of the roller 190. The deflector arms in region 401 are in either the first or second position. Therefore, the device 100 may define a plurality of fluid channels according to a pattern, depending on the pattern of fluid to be formed on the roller 190. For example, the region of the surface of the roller 190 corresponding to the region 402 is to not be coated in fluid (air in this region being directed toward the pores of the roller to discharge fluid therein) but the region of the surface of the roller 190 corresponding to the region 403 is to be covered in fluid (air in this region being directed away from the pores of the roller so as not to discharge fluid therein).

In the examples shown in FIGS. 3 and 4, the deflector blade 180 is not explicitly shown but the deflector blade 180 may be used in some examples. In such examples the blade 180 may comprise a 2-dimensional tray to collect and route the expelled air from the device (expelled by the second fluid channels). The curved surface 103 may extend for the length of the fluid ejection device 100 such that all air expelled by the device 100 is routed through the first or second fluid channel 102a, 102b (and therefore directed toward or away from a roller 190). The length of the device 100 may therefore be defined as the dimension of the device 100 that is parallel to the length of the roller 190. The curvature of the curved surface 103 may be constant along the length of the fluid ejection device 100 and therefore along the length of the roller 190. The curved surface 103 of the device may comprise substantially constant cross sections along the length of the device 100. The curved surface 130 may therefore curve away from a central of the device 100 and/or the device housing 101 and/or one of the housings 101a, 101b and/or the fluid channel 102 etc. substantially along the length of the device 100.

To achieve the selective jetting of a fluid (e.g. an air flow) out of the device the movable guide element, or deflector arm 104 may be movable between the first and second positions, thereby operating the device according to first and second modes, under the control of a controller. For example, the deflector arm 104 may comprise a piezoelectric element and the position of the blade may be changeable by varying the amount of electric current through the arm. In this way each or the deflector arm may be independently movable so that individual pores can be selectively discharged and, in turn, a fluid pattern may be formed on the surface of the roller 190.

Some examples herein therefore provide an apparatus 100 for directing a fluid. The apparatus 100 is positionable proximate a first roller 190 of a printing system. The apparatus 100 comprises a movable guide element 104 for directing fluid towards the first roller 190. The movable guide element 104 is movable between a first position (see FIGS. 1A and 2A) and a second position (FIGS. 1B and 2B). In the first position the movable guide element 104 is to direct fluid towards a first outlet (see FIG. 2A, the outlet between surface 109a and the movable guide element 104) and out of the apparatus 100 in a first direction A, towards the first roller 190 (e.g. a surface thereof), and in the second position the movable guide element 104 is to direct fluid towards a second outlet (see FIG. 2B, the outlet between surface 103 and the movable guide element 104), the second outlet comprising a curved edge 103 such that fluid is directed out of the apparatus 100 in a second direction B (the directions A and B being different). The curved edge 103 curves away from the second fluid outlet to change the direction of fluid as the fluid exits the opening. In the first position the guide element 104 may be to direct fluid through a first fluid channel 102a and in the second position the guide element 104 may be to direct fluid through a second fluid channel 102b. The cured edge 103 may extend away from the second fluid channel 102. Each of the first and second fluid outlets may extend the length of the apparatus 100 (as shown in FIGS. 3 and 4). The curved edge 103 extends the length of the apparatus 100 (as shown in FIGS. 3 and 4).

With reference to FIG. 3, some examples provide a print apparatus 200 comprising a roller 190 having a surface 194 on which to receive a fluid (not shown in FIG. 4) and a fluid delivery unit 100 operable in a first mode (FIGS. 1A and 2A) to direct fluid through a first fluid channel 102a towards the surface 194 of the roller 190 and operable in a second mode (FIGS. 1B and 2B) to direct fluid through a second fluid channel 102b having an opening comprising a curved surface 103 to cause fluid in the second fluid channel 102b to be deflected away (see arrow B) from the surface 194 of the roller 190 (e.g. as fluid exits the channel). The roller 190 in this example comprises a number of cavities 193 for storing a fluid therein (e.g. the surface 194 of the roller 190 may comprise the cavities 193) and wherein the fluid delivery unit 100 is to direct air toward a cavity of the roller. The apparatus 200 comprising a blade (see blade 180 in FIGS. 2A and 2B) which is to prevent fluid exiting the opening of the second fluid channel 102b from being directed toward the roller 190. Put another way, the blade 180 is to direct fluid (see arrow B) away from the roller 190, or to continue to direct fuid away from the surface 194 of the roller. The openings 102a and/or 102b and the curved surface 103 may extend the length of the roller (see FIGS. 3 and 4).

The device 100 (or apparatus or delivery unit) as described above may comprise an “air knife”, for example a digital air knife sometimes abbreviated to a DAK. In such an air knife, the fluid comprises a gas, for example air, for example pressurised air to produce a jet flow and/or a jet stream of air. In other words, the fluid expelled by the device 100 may be discharged from an opening of the device at a high velocity. The velocity may be sufficient such that when the fluid is directed toward a cavity of the roller filled with fluid (e.g. a liquid) then the liquid in the cavity is expelled. An image can therefore be created upon the surface of an anilox roller by selectively removing liquid out of anilox cavities. The movable guide element, or deflector beam, according to the examples presented herein allows the device to selectively apply jet flow in specific areas on the anilox roller to form the fluid image thereon. This image can then be transferred to a substrate (e.g. via the intermediate transfer to another roller, for example a rubber roller). The curved surface of the device allows the jet flow to be shifted away from the roller without the use of a separate component. In other words, the device itself is able to direct air toward the roller and to deflect the air away from the roller. As illustrated in the above figures, the jet flow attaches itself to the curved surface and remains attached, following the curvature of the surface. In this way, the devices herein utilise the Coanda effect to bend the jet flow away from a target area on the roller when the jet flow is not to discharge the pores of the roller. The surface is therefore curved so as to pull the jet flow away from the roller. This allows the device to be placed closer to the roller than in examples where a separate component is used to divert the air flow. In turn, this improves the performance of the device. This also makes the design, manufacture, and assembly of the device easier and simpler, and no calibration is needed for a separate component to cause the air flow to curve.

While the apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A fluid ejection device comprising
a housing comprising a first housing portion and a second housing portion defining a fluid ejection aperture therebetween, the fluid ejection aperture to direct fluid towards a roller; and
a deflector arm movable within the fluid ejection aperture between first and second positions wherein, in the first position, the deflector arm is proximate the second housing portion to thereby direct fluid between the deflector arm and the first housing portion and toward a target area on a surface of the roller and, in the second position, the deflector arm is proximate the first housing portion to thereby direct fluid between the deflector arm and the second housing portion, wherein the second housing portion comprises a curved surface such that, when the deflector arm is in the second position, fluid is directed away from the target area.

2. A fluid ejection device according to claim 1, wherein then deflector arm and first housing portion define a first fluid channel and wherein the deflector arm and the second housing portion define a second fluid channel and wherein the curved surface defines an opening of the second fluid channel.

3. A fluid ejection device according to claim 2, wherein the curved surface defines a curved edge of the opening.

4. A fluid ejection device according to claim 2, wherein the curved surface curves away from the second fluid channel to change the direction of fluid as fluid exits the opening.

5. A fluid ejection device according to claim 1, wherein the curved surface extends along the length of the fluid ejection device.

6. A fluid ejection device according to claim 1, wherein the curvature of the curved surface is constant along the length of the fluid ejection device.

7. A fluid ejection device according to claim 1, wherein the fluid ejection device comprises a plurality of deflector arms, and wherein each deflector arm is movable between first and second positions in which, in the first position, each deflector arm is proximate the second housing portion and, in the second position, each deflector arm, is proximate the first housing portion.

8. An apparatus for directing a fluid, the being positionable proximate a first roller of a printing system, the apparatus comprising:
a movable guide element for directing fluid towards the first roller, wherein the guide element is movable between a first position in which the guide element is to direct fluid towards a first fluid outlet and out of the apparatus in a first direction towards the first roller and a second position in which the guide element is to direct fluid towards a second fluid outlet, the second fluid outlet comprising a curved edge such that fluid is directed out of the apparatus in a second direction, the second direction being different to the first direction.

9. An apparatus according to claim 8, wherein the curved edge curves away from the second fluid outlet to change the direction of fluid as fluid exits the opening.

10. An apparatus according to claim 8, wherein each of the first and second fluid outlets extend the length of the apparatus.

11. An apparatus according to claim 8 wherein the curved edge extends the length of the apparatus.

12. A print apparatus comprising:
a roller having a surface on which to receive a fluid; and
fluid delivery unit operable in a first mode to direct a fluid through a first fluid channel towards the surface of the roller and operable in a second mode to direct the fluid through a second fluid channel having an opening comprising a curved surface to cause fluid in the second fluid channel to be deflected away from the surface of the roller.

13. A print apparatus according to claim 12, wherein the roller comprises a number of cavities for storing a fluid therein and wherein the fluid delivery unit is to direct air toward a cavity of the roller.

14. A print apparatus according to claim 12, further comprising a blade to prevent fluid exiting the opening of the second fluid channel from being directed toward the roller.

15. A print apparatus according to claim 12, wherein the opening and curved surface extend across the length of the roller.
